(19) United States
(12) Patent Application Publication
(10) Pub. No.: US 2010/0214274 A1
(43) Pub. Date: Aug. 26, 2010

(54) ACTIVE-MATRIX DISPLAY PANEL AND DEVICE, AND METHOD FOR DRIVING SAME

(76) Inventor: Keiichi Yamamoto, Osaka (JP)

Correspondence Address: HARNESS, DICKEY & PIERCE, P.L.C., P.O. BOX 8910, RESTON, VA, 20195, US

(21) Appl. No.: 12/733,230

(22) PCT Filed: May 30, 2008
(86) PCT No.: PCT/JP2008/059992

§ 371 Date: Feb. 18, 2010

(30) Foreign Application Priority Data
Oct. 12, 2007 (JP) 2007-266262

(51) Int. Cl. G06F 3/038

(52) U.S. Cl. 345/206; 345/76

(57) ABSTRACT

In one embodiment of the present invention, to provide an active-matrix display device with simplified features for black insertion drive in pixel formation portions and a display state before a black display being readily restorable after the black display, each pixel formation portion of the present display device includes provided therein a coupling capacitance and a coupling line, which is parallel to a scanning signal line, and therefore can be driven at a suitable voltage, so that a gate voltage at a drive element can be set to a level allowing a black display via the coupling capacitance, and the coupling capacitance is small-sized and therefore can be readily formed when compared to a TFT. Also, by changing the potential on the coupling line by the same amount of change but in the opposite direction to that for the change in potential on the coupling line for setting the gate voltage of the drive element to a level allowing a black display, the gate voltage can be readily restored such that the data signal potential after the black display corresponds to the display state before the black display.

### TECHNICAL FIELD

The present invention relates to active-matrix display panels and devices, and methods for driving the same, more specifically to an active-matrix display panel and device including drive elements for driving electro-optic elements, such as light-emitting elements, and a method for driving the same.

### BACKGROUND ART

In recent years, with growing demand for lightweight, low-profile, and fast-response displays, active research and development has been carried out on display devices, such as organic EL (Electro Luminescence) displays and FEDs (Field Emission Displays). Also, while matrix display devices are generally classified into passive-matrix display devices and active-matrix display devices, recent years have seen active-matrix display devices becoming mainstream to satisfy requirements for an increased number of display pixels and an increased display speed resulting from increased resolution.

In particular, active-matrix organic EL displays have come to prevail in recent years, but the organic EL displays are hold-type display devices, which might cause motion blur in displayed images unlike impulse-type display devices such as cathode-ray tube displays. Conventionally, a black insertion drive system is known as a drive system for reducing such motion blur in hold-type display devices.

The black insertion drive system provides drive such that a black image is inserted at the beginning or end of each frame interval or between frame intervals. However, in order to insert the black image, typical active-matrix display devices are required to perform scanning for displaying the black image with pixels in each row, in addition to scanning for a normal display, and therefore in the case where one black image is inserted per frame, scanning is required twice per frame.

For example, conventionally, there is an organic EL display device in which one frame is divided into two sub-frames such that a normal display is provided during one sub-frame, and a black image is displayed during the other sub-frame (see Patent Document 1 below). Such drive can reduce motion blur but requires a scanning speed twice the normal speed, resulting in increased device production cost for achieving this and increased power consumption.

On the other hand, there is a conventional display device employing a drive system different from the black insertion drive system, in which first and second scanning signal lines are provided for each row such that the first scanning signal line transmits a scanning signal for a normal display with pixels in the row and the second scanning signal line transmits a blanking signal for blanking the display with pixels in the row, and switching elements are provided for each pixel to blank pixel display data being held (typically, in a predetermined capacitance) upon reception of a blanking signal for the pixel (see Patent Document 2 below). In the case of this conventional display device, during one frame interval, scanning is performed for providing a normal display through the first scanning signal line, and thereafter during the same frame interval, scanning is performed for blanking the display through the second scanning signal line, thereby making it possible to provide a display at the same scanning speed as those of typical display devices.

Here, the conventional display device will be described regarding the configuration and operation of a pixel formation portion in a display portion. FIG. 5 is a circuit diagram illustrating an equivalent circuit for the pixel formation portion. The pixel formation portion shown in FIG. 5 includes a current-driven light-emitting element 93, a data signal control switching element 91, a light-emitting element driving drive element 92, a blanking switching element 99, and a retention capacitance 94, and also has arranged thereon a data signal line 95 for providing a data signal, a scanning signal line 96 for providing a scanning signal, as well as a light-emitting element drive power supply line 97 for providing current for driving the light-emitting element 93, and a blanking line 98 for providing a blanking signal.

As shown in FIG. 5, the switching element 91 has a source terminal connected to the data signal line 95, a gate terminal connected to the scanning signal line 96, and a drain terminal connected to one terminal of the retention capacitance 94 and a gate terminal of the drive element 92. The other terminal of the retention capacitance 94 is connected to the power supply line 97. The blanking switching element 99 has a gate terminal connected to the blanking line 98, a source terminal connected to the aforementioned one terminal of the retention capacitance 94, and a drain terminal connected to the aforementioned other terminal of the retention capacitance 94. The drive element 92 has a source terminal connected to the power supply line 97, and a drain terminal connected to an anode A of the light-emitting element 93. Also, the light-emitting element 93 has a cathode C connected to an unillustrated common electrode formed in a layer overlying the pixel formation portion.

First, when the scanning signal on the scanning signal line 96 is active, the switching element 91 is turned ON, so that a voltage corresponding to the value of a data signal supplied to the data signal line 95 is supplied to the gate of the drive element 92 and the retention capacitance 94 via the switching element 91, and a corresponding charge accumulates in the retention capacitance 94. Current flows from the drive element 92 to the light-emitting element 93 in accordance with the voltage, and therefore the light-emitting element 93 emits light with predetermined brightness.

Next, because the electric conductivity of the drive element 92 is controlled in accordance with the charge accumulated in the retention capacitance 94, the light-emitting element 93 keeps emitting light with the predetermined brightness even after the switching element 91 is turned OFF. Thereafter, when the blanking signal on the blanking line 98 is activated, the switching element 99 is turned ON, so that both terminals of the retention capacitance 94 are connected thereto and therefore equalized in potential, releasing the charge accumulated in the retention capacitance 94. As a result, no current flows from the drive element 92 to the light-emitting element 93, so that the light-emitting element 93 stops emitting light.

Here, it is conceivable that scanning for activating the blanking line 98 to blank display as described above can function as scanning for displaying a black image. Therefore, conceivably, the drive system of the conventional display device can be used as a black insertion drive system.

[Patent Document 1] Japanese Laid-Open Patent Publication No. 2007-114286

[Patent Document 2] Japanese Laid-Open Patent Publication No. 2006-337991

### DISCLOSURE OF THE INVENTION

### Problems to be Solved by the Invention

However, the conventional display device requires the blanking switching element 99 for each pixel formation portion, and therefore, typically, blanking thin-film transistors are additionally required to be formed in the pixel formation portions, resulting in a complex structure, hence increased production cost.

Also, in the case of the conventional display device, data being held (typically, in the retention capacitance) for a pixel display is completely blanked, and therefore it is not possible to restore the data without writing new data. Accordingly, in order to realize, for example, a high drive frequency black insertion drive system intended for eliminating screen flickering, in which a black image is displayed twice per frame, a data driver with at least twice the conventional writing speed is required, and a memory for storing image data that has been already written once is additionally required, which further increases production cost.

Therefore, an objective of the present invention is to provide an active-matrix display panel and device, and a method for driving the same, with simplified features for black insertion drive in pixel formation portions and a display state before a black display being readily restorable after the black display.

### Solution to the Problems

A first aspect of the present invention is directed to an active-matrix display panel, comprising:
a plurality of pixel formation portions for forming an image to be displayed;
a plurality of video signal lines for transmitting a plurality of video signals representing the image to be displayed to the pixel formation portions;
a plurality of scanning signal lines crossing the video signal lines; and
a plurality of coupling lines provided along their respective scanning signal lines, wherein,
the pixel formation portions are arranged in a matrix, in correspondence with the intersections between the video signal lines and the scanning signal lines, and
each of the pixel formation portions includes:
   an electro-optic element to be driven by a voltage or current;
   a drive element having a control terminal and providing the voltage or current to be applied to the electro-optic element in accordance with a voltage applied to the control terminal;
   a switching element for, when a corresponding scanning signal line is selected, providing the video signal transmitted through a corresponding video signal line to the control terminal;
   a retention capacitance connected at one terminal to the control terminal and retaining the voltage applied to the control terminal upon selection of the corresponding scanning signal line; and
   a coupling capacitance connected at one terminal to the control terminal and at the other terminal to a corresponding coupling line.

In a second aspect of the present invention, based on the first aspect of the invention, the electro-optic element is an organic EL (Electro Luminescence) element.

A third aspect of the present invention is directed to an active-matrix display device, comprising:
an active-matrix display panel of the first aspect of the invention,
a scanning signal line driver circuit for selectively driving the scanning signal lines;
a video signal line driver circuit for providing the video signals corresponding to an image to be displayed to the video signal lines; and
a coupling line driver circuit for changing a voltage on a corresponding coupling line at the start of a predetermined light-out period to be set within one frame interval in which to display a single image after selecting a corresponding scanning signal line for each of the coupling lines, the voltage being changed such that a voltage applied to the control terminal during the light-out period is set to a level allowing the electro-optic element to provide a black display.

In a fourth aspect of the present invention, based on the third aspect of the invention, the active-matrix display panel further includes power supply lines for providing a predetermined voltage or current to the drive elements, the power supply lines are connected to the electro-optic elements via the drive elements, the coupling line driver circuit changes the voltage on the coupling line, thereby setting a voltage applied to the control terminal acting as a gate terminal of the drive element during the light-out period to a level allowing the electro-optic element to provide a black display, the level being variable in a range including values close to the voltage on the power supply line.

In a fifth aspect of the present invention, based on the third aspect of the invention, the coupling line driver circuit brings the voltage on the coupling line back to its pre-change level immediately after the light-out period.

In a sixth aspect of the present invention, based on the fifth aspect of the invention, the coupling line driver circuit changes the voltage on the corresponding coupling line such that the voltage on the coupling line is brought back to its pre-change level immediately after a first light-out cycle within the light-out period, and the voltage applied to the control terminal during the light-out period is set again to a level allowing the electro-optic element to provide a black display at the start of a second light-out cycle being set at a predetermined time period apart.

A seventh aspect of the present invention is directed to a method for driving an active-matrix display device provided with an active-matrix display panel including a plurality of pixel formation portions for forming an image to be displayed, a plurality of video signal lines for transmitting a plurality of video signals representing the image to be displayed to the pixel formation portions, a plurality of scanning signal lines crossing the video signal lines, and a plurality of coupling lines provided along their respective scanning signal lines, the pixel formation portions being arranged in a matrix, in correspondence with the intersections between the video signal lines and the scanning signal lines, each of the pixel formation portions including an electro-optic element to be driven by a voltage or current, a drive element having a control terminal and providing a voltage or current to be applied to the electro-optic element in accordance with a voltage applied to the control terminal, a switching element for, when a corresponding scanning signal line is selected, providing the video signal transmitted through a corresponding video signal line to the control terminal, a retention capacitance connected at one terminal to the control terminal and retaining a voltage applied to the control terminal upon selection of the corresponding scanning signal line, and a coupling capacitance connected at one terminal to the control terminal and at the other terminal to a corresponding coupling line, the method comprising:
a scanning signal line driving step for selectively driving the scanning signal lines;
a video signal line driving step for providing the video signals corresponding to an image to be displayed to the video signal lines; and
a coupling line driving step for changing a voltage on a corresponding coupling line at the start of a predetermined light-out period to be set within one frame interval in which to display a single image after selecting a corresponding scanning signal line for each of the coupling lines, the voltage being changed such that a voltage applied to the control terminal during the light-out period is set to a level allowing the electro-optic element to provide a black display.

### Effect of the Invention

According to the first aspect of the invention, each pixel formation portion of the active-matrix display panel includes a coupling capacitance and a coupling line provided along a scanning signal line, and the coupling capacitance is connected at one terminal to a control terminal of a drive element (e.g., a gate terminal of a field-effect transistor) and at the other end to the coupling line. With this simplified display panel configuration, the coupling line is driven by a suitable voltage, so that the voltage at the control terminal of the drive element can be readily set to a level allowing a black display via the coupling capacitance, and therefore the features for black insertion drive in pixel formation portions can be simplified, for example, even when compared to the configuration in which switching elements are provided for black insertion drive.

Also, the control terminal of the drive element is connected to one terminal of the retention capacitance and also to one terminal of the coupling capacitance, and therefore the sum of these capacitance values may be equal to a conventional retention capacitance value. Accordingly, the coupling capacitance can be readily formed in the pixel formation portion, which also makes it possible to simplify the features for black insertion drive in pixel formation portions.

According to the second aspect of the invention, since the electro-optic element is an organic EL element, which is widely used as an element for emitting light when current is applied thereto, a display panel with high display quality can be produced at low cost.

According to the third aspect of the invention, the display panel of the first aspect of the invention is provided, and the coupling line driver circuit changes a voltage on a corresponding coupling line at the start of the light-out period, such that a voltage applied to the control terminal during the light-out period is set to a level allowing a black display. With this configuration, the features for black insertion drive in pixel formation portions can be simplified.

According to the fourth aspect of the invention, since the power supply lines are provided and the coupling line driver circuit sets a voltage applied to the gate terminal of the drive element during the light-out period to a level allowing a black display, the level being variable in the range including values close to the voltage on the power supply line, the features for black insertion drive in pixel formation portions can be simplified by using the values close to the voltage on the power supply line.

According to the fifth aspect of the invention, since the coupling line driver circuit brings the voltage on the coupling line to a pre-change level immediately after the light-out period, the display state before a black display can be readily restored after the black display.

According to the sixth aspect of the invention, since the coupling line driver circuit makes it possible to provide a black display at least twice, i.e., at the start of both the first and second light-out cycles In this manner, by providing a display at such a high (pseudo) drive frequency, screen flickering can be reduced, resulting in a high-quality image display.

According to the seventh aspect of the invention, a method for driving an active-matrix display device can achieve the same effects as in the first aspect of the invention.

### BRIEF DESCRIPTION OF THE DRAWINGS

FIG. 1 is a block diagram illustrating the overall configuration of an active-matrix liquid crystal display device according to an embodiment of the present invention.

FIG. 2 is a circuit diagram illustrating an equivalent circuit for a pixel formation portion in the embodiment.

FIG. 3 is a diagram showing periods for display rows in which a normal image is displayed and in which a black image is displayed.

FIG. 4 is a diagram illustrating potential changes on a scanning signal line and a coupling line, as well as potential changes at gate terminals of drive elements in the embodiment.

FIG. 5 is a circuit diagram illustrating an equivalent circuit for a pixel formation portion in the conventional art.

### DESCRIPTION OF THE REFERENCE CHARACTERS

1, 91 data signal control switching element
2, 92 light-emitting element drive element
3, 93 light-emitting element
4, 94 retention capacitance
5, 95 data signal line
6, 96 scanning signal line
7, 97 light-emitting element drive power supply line
8 coupling line
9 coupling capacitance
98 blanking line
99 blanking switching element
100 display portion
200 scanning signal line driver circuit
300 data signal line driver circuit
400 display control circuit
500 current supply portion
600 coupling line driver circuit
Sel scanning signal
Data data signal
VDD power source voltage
VC coupling line drive signal

### BEST MODE FOR CARRYING OUT THE INVENTION

<1. Overall Configuration and Operation of the Organic EL Display Device>

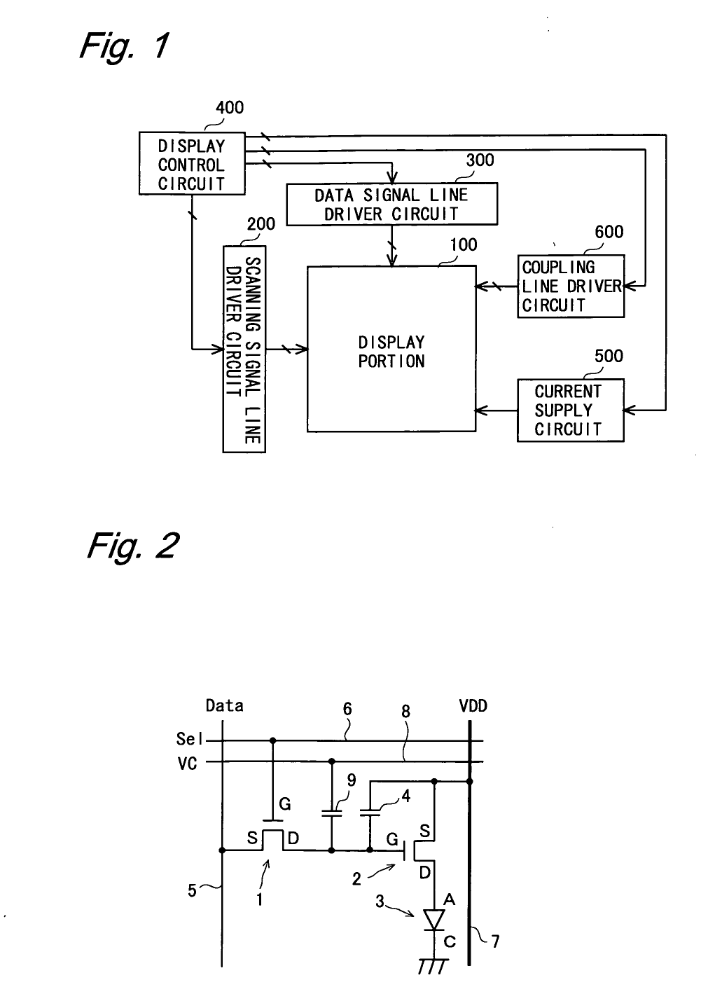

FIG. 1 is a block diagram illustrating the overall configuration of an active-matrix display device according to an embodiment of the present invention. The display device includes a display portion (display panel) 100, a scanning signal line driver circuit 200, a data signal line driver circuit 300, a display control circuit 400, a current supply portion 500, and a coupling line driver circuit 600.

The display portion 100 is a display panel configured by arranging a plurality of pixel formation portions, each including an organic EL light-emitting element and a thin-film transistor to be described later, in an m×n matrix on a glass substrate. Note that such a configuration of the display portion 100 is well-known, and therefore any detailed description thereof will be omitted.

The scanning signal line driver circuit 200 is connected to n scanning signal lines, and outputs scanning signals having a predetermined cycle to the scanning signal lines. The data signal line driver circuit 300 is connected to m data signal lines (video signal lines), and outputs data signals for controlling emission brightness of the light-emitting elements. The display control circuit 400 outputs predetermined control signals for generating the scanning signals and the data signals to the scanning signal line driver circuit 200 and the data signal line driver circuit 300, and also outputs predetermined control signals for generating coupling line drive signals, which are used for driving coupling lines to be described later, to the coupling line driver circuit 600. The current supply portion 500 is a drive power source connected to a plurality of power supply lines to supply current for driving the light-emitting elements.

While the scanning signal line driver circuit 200, the data signal line driver circuit 300, the coupling line driver circuit 600, and the display control circuit 400 are formed independently of the display portion (display panel) 100, part or all of them may be formed integrally (monolithically) with the display panel.

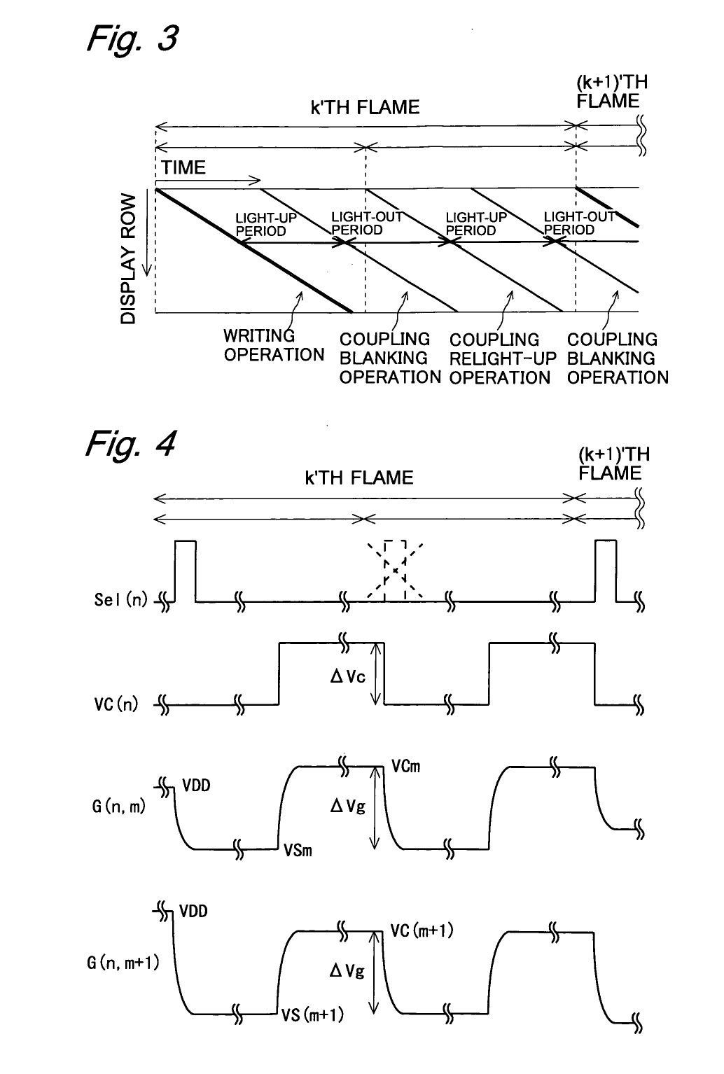

The display portion 100 of the display device according to the present embodiment will now be described regarding the configuration and operation of the pixel formation portion. FIG. 2 is a circuit diagram illustrating an equivalent circuit for the pixel formation portion. The pixel formation portion shown in FIG. 2 includes a relatively inexpensive organic EL light-emitting element 3 (hereinafter, abbreviated as a “light-emitting element 3”) to be driven by current and emit highly bright light, a data signal control switching element 1 (hereinafter, abbreviated as a “switching element 1”), a light-emitting element drive element 2 (hereinafter, abbreviated as a “drive element 2”), a retention capacitance 4, and a coupling capacitance 9 to be described in detail later, and also has provided thereon a data signal line 5 for providing a data signal (in the figure, “Data” also being shown to indicate the data signal), and a scanning signal line 6 for providing a scanning signal (in the figure, “Sel” also being shown to indicate the scanning signal), as well as a light-emitting element drive power supply line 7 for providing current for driving the light-emitting element 3 (hereinafter, simply abbreviated as a “power supply line 7”; “VDD” also being shown to indicate the power source voltage) and a coupling line 8 for providing a coupling line drive signal (“VC” also being shown to indicate the coupling line drive signal). Note that the switching element 1 and the drive element 2 are thin-film transistors made of polysilicon or amorphous silicon, specifically, p-type field-effect transistors.

As shown in FIG. 2, the data signal line 5 and the scanning signal line 6 are arranged perpendicular to each other, the data signal line 5 and the power supply line 7 are arranged in parallel to each other, and the scanning signal line 6 and the coupling line 8 are arranged in parallel to each other. Note that the power supply line 7 does not always have to be arranged in parallel to the data signal line 5 so long as power can be supplied to the pixel formation portion. Also, the switching element 1 has a source terminal S connected to the data signal line 5, a gate terminal G connected to the scanning signal line 6, and a drain terminal D connected to one terminal of the retention capacitance 4 and a gate terminal G of the drive element 2. The other terminal of the retention capacitance 4 is connected to the power supply line 7. The coupling capacitance 9 has one terminal connected to the coupling line 8 and the other terminal to the aforementioned one terminal of the retention capacitance 4 and the gate terminal G of the drive element 2. The drive element 2 has a source terminal S connected to the power supply line 7 and a drain terminal D connected to an anode A of the light-emitting element 3. Also, the light-emitting element 3 has a cathode C connected to an unillustrated common electrode formed in a layer overlying the pixel formation portion.

Furthermore, the operation of the pixel circuit will be described. First, when the scanning signal on the scanning signal line 6 is active, the switching element 1 is turned ON, so that a voltage corresponding to the value of the data signal supplied to the data signal line 5 is supplied to the gate of the drive element 2, the retention capacitance 4, and the coupling capacitance 9 via the switching element 1, and a corresponding charge accumulates in the capacitances.

Note that the coupling capacitance 9 is not provided in the conventional organic EL display device, and only the retention capacitance is provided in the conventional configuration. Here, the capacitance value of the conventional retention capacitance is assumed to be almost equal to the sum of capacitance values of the retention capacitance 4 and the coupling capacitance 9 of the organic EL display device in the present embodiment. Accordingly, current flows from the drive element 2 to the light-emitting element 3 in accordance with voltages retained in the retention capacitance 4 and the coupling capacitance 9, so that the light-emitting element 3 emits light with predetermined brightness.

Next, because the electric conductivity of the drive element 2 is controlled in accordance with the charge accumulated in the retention capacitance 4 and the coupling capacitance 9, the light-emitting element 3 keeps emitting light with the predetermined brightness even after the switching element 1 is turned OFF. Such a pixel circuit is referred to as a voltage-programmed circuit (or a voltage-controlled circuit).

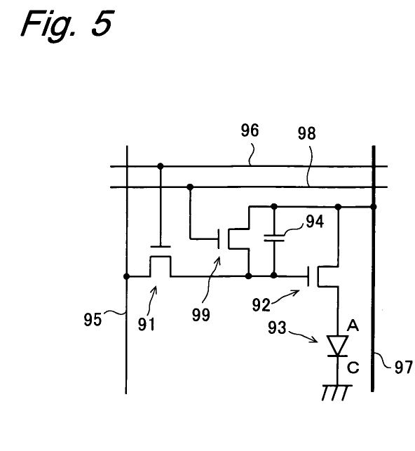

Here, in the case where a black image is inserted after predetermined pixel data is written to the pixel circuit in the manner described above, the conventional display device shown in FIG. 5, which includes the blanking lines 98 and the blanking switching elements 99, displays a black image by activating the blanking lines 98 and thereby blanking pixel data retained in the retention capacitances 94, as described above. While the display device of the present embodiment displays a black image by changing potentials on the coupling lines 8, the display device of the present embodiment, unlike the conventional display device, does not include the blanking switching elements 99, and instead simply includes the coupling capacitances 9. Hereinafter, the pixel circuit in the present embodiment will be described regarding the operation for displaying the black image, i.e., the operation related to black insertion drive.

<2. Operation Related to Black Insertion Drive>

FIG. 3 is a diagram showing periods for display rows in which a normal image is displayed and in which a black image is displayed. Here, the light-up period shown in FIG. 3 is intended to mean the period in which a normal image is displayed, whereas the light-out period is intended to mean the period in which a black image is displayed.

Also, in FIG. 3, the light-up period and the light-out period are shown within a k'th (where k is an arbitrary integer) frame interval in which a single image is displayed, and it can be appreciated that each period is delayed as the display row number increases (i.e., toward the bottom display row) at time points corresponding scanning signal lines are sequentially selected (activated) by the scanning signal line driver circuit 200.

First, when the writing operation shown in FIG. 3 starts, i.e., when the operation as described earlier, in which a corresponding scanning signal line 6 is selected, so that the switching element 1 is turned ON and a voltage corresponding to the value of the data signal supplied to the data signal line 5 is written to the retention capacitance 4 and the coupling capacitance 9, starts, the light-emitting element 3 starts emitting light, and the state of emission is maintained during the light-up period.

Thereafter, the coupling blanking operation shown in FIG. 3 is performed, i.e., the operation in which the potential on a corresponding coupling line 8 is changed to blank pixel data written in the retention capacitance 4 via the coupling capacitance 9 is performed. Note that the “blank” here is not intended to mean that the charge written in the retention capacitance 4 is simply removed, but the charge is changed only by a predetermined degree. This will be described in further detail.

First, in the case where the amount of change in potential on a coupling line drive signal VC provided from the coupling line driver circuit 600 to the corresponding coupling line 8 is ΔVc, the capacitance value of the coupling capacitance 9 is Cc, and the capacitance value of the retention capacitance 4 is Ch, the amount of change in potential ΔVg at the gate terminal of the drive element 2 can be represented by equation (1) below with reference to FIG. 2. Note that Cα is a parasitic capacitance.

ΔVg=ΔVc·Cc/(Ch+Cc+Cα) (1)

Accordingly, by changing the voltage applied to the gate terminal of the drive element 2 by ΔVg to a value close to the power source voltage VDD (or typically, just the power source voltage VDD), the gate-source voltage of the drive element 2 falls to an ON-voltage or lower (typically, zero), so that the drive element 2 is turned OFF, and the light-emitting element 3 stops emitting light.

However, the voltage that is applied to the gate terminal of the drive element 2 during the light-up period varies in the range from the maximum to minimum value in accordance with a provided data signal, and therefore the voltage has to be set to such a value that a black display is provided no matter what value in the range the voltage takes. Therefore, specifically, in the case where a data signal representing a white display (maximum brightness) is provided, when the voltage applied to the gate terminal of the drive element 2 is changed by ΔVg, the value close to the power source voltage VDD that is to be set for the gate terminal is a voltage value greater than or equal to the same voltage as that applied to the gate terminal of the drive element 2 when a data signal representing a black display (minimum brightness) is provided.

In this manner, when the coupling blanking operation is performed by changing the potential on the coupling line 8 by ΔVc, the potential at the gate terminal of the drive element 2 changes by ΔVg, and the potential after change remains in the retention capacitance 4 and the coupling capacitance 9. At this time, the light-emitting element 3 remains in the state where it keeps stopping light emission (strictly, the state of black display).

Thereafter, the coupling relight-up operation shown in FIG. 3 is performed, i.e., the operation is performed to change the potential on the corresponding coupling line 8 to the potential before change, thereby restoring the potential maintained in the retention capacitance 4 via the coupling capacitance 9 to the state before pixel data has been blanked. Here, the coupling line 8 is driven such that the potential is changed by the same amount of change in potential ΔVc as that in the coupling blanking operation and in a direction opposite to that for blanking. As a result, the coupling blanking operation restores the voltage applied to the gate terminal of the drive element 2 to the potential before the aforementioned change by ΔVg, i.e., the potential at the gate terminal of the drive element 2 is restored to the potential corj responding to pixel data for a normal image display.

In this manner, the potential on the coupling line 8 is changed by ΔVc in the coupling blanking operation, and by the same amount but in the opposite direction in the coupling relight-up operation, so that the amount of charge written in the retention capacitance 4 is changed by a predetermined degree, and then the predetermined amount is added again, thereby restoring the original state. Referring next to FIG. 4, specific potential changes will be described in detail.

FIG. 4 is a diagram illustrating potential changes on the scanning signal line and the coupling line, as well as potential changes at the gate terminals of the drive elements. More specifically, FIG. 4 shows potentials in the display portion 100 during the k'th frame and a part of the (k+1)'th frame subsequent thereto, including the potential Sel(n) on the n'th row scanning signal line 6, the potential VC(n) on the n'th row coupling line 8, the gate terminal potential G(n,m) of the drive element 2 of the n'th row pixel circuit in the m'th column, and the gate terminal potential G (n,m+1) of the drive element 2 of the n'th row pixel circuit in the (m+1)'th column to the right thereof.

First, when the potential Sel(n) on the scanning signal line 6 is turned into an ON-potential (activated), the gate terminal potential G(n,m) changes from the power source potential VDD to a data signal potential VSm on a corresponding data signal line 5. Similarly, the gate terminal potential G(n,m+1) changes from the power source potential VDD to a data signal potential VS(m+1) on a corresponding data signal line 5. Here, the data signal potential VS(m+1) is lower than the data signal potential VSm (i.e., it falls away from the power source potential VDD).

Strictly speaking, when the potential Sel(n) on the scanning signal line 6 falls, the gate terminal potential G(n,m) or G(n,m+1) is further decreased (reduced) to below the data signal potential VSm or VS(m+1) by a parasitic capacitance and suchlike between the gate and drain terminals of the switching element 1 in accordance with the change of potential on the scanning signal line 6, but any illustrations related to this are omitted in FIG. 4, etc., for convenience of explanation. Also, as described above, the potentials are maintained even after they are turned into OFF-potentials (non-active) on the scanning signal lines 6 by the retention capacitances 4 and the coupling capacitances 9 in their corresponding pixel circuits.

Thereafter, when the potential VC(n) on the n'th row coupling line 8 rises by ΔVc at the start of the aforementioned coupling blanking operation, because of the coupling capacitance 9, the gate terminal potential G(n,m) changes by ΔVg from the data signal potential VSm to VCm, which is a voltage value close to the power source potential VDD. The voltage value VCm is higher than the power source potential VDD, and therefore the drive element 2 is turned OFF, so that the light-emitting element 3 is turned into a black display state. Also, the gate terminal potential G(n,m+1) changes by ΔVg from the data signal potential VS(m+1) to VC(m+1), which is a voltage value close to the power source potential VDD. The voltage value VC(m+1) is lower than the power source potential VDD, but it is also lower than an ON-voltage (strictly, a voltage for black display), and therefore the light-emitting element 3 is turned into a black display state.

Here, because the provided data signal voltage varies from one pixel circuit to another, the gate terminal potential differs between pixel circuits, but the pixel circuits are common in that the difference between the pre-change potential and the post-change potential is always ΔVg, and therefore data signal potentials can be restored.

Specifically, when the potential VC(n) on the n'th row coupling line 8 falls by ΔVc at the start of the aforementioned coupling relight-up operation after the coupling blanking operation, because of the coupling capacitance 9, the gate terminal potential G(n,m) changes by ΔVg from the potential VCm back to the data signal potential VSm. Also, the gate terminal potential G(n,m+1) changes by ΔVg from the potential VC(m+1) back to the data signal potential VS(m+1). The subsequent coupling blanking operation is the same as described above.

<3. Effect>

As described above, the active-matrix display device of the present embodiment has the coupling capacitances 9 provided in the pixel formation portions and the coupling lines 8 provided in parallel to the scanning signal lines, thereby performing the coupling blanking operation for driving at a suitable voltage, so that the gate voltage of the drive elements 2 can be readily set to a voltage for black display by means of the coupling capacitances 9. Also, the coupling capacitance 9 retains the data signal potential in conjunction with the retention capacitance 4, and therefore the sum of the capacitances is almost equal to the conventional retention capacitance value. Accordingly, the coupling capacitance 9 can be readily formed in the pixel formation portion, along with the retention capacitance 4, especially when compared to the case where switching elements, such as thin-film transistors, are formed. Note that since the sum of the capacitances is almost equal to the conventional retention capacitance value, provision of the coupling capacitance 9 does not result in any disadvantages over the conventional art, e.g., the time for charging (the capacitances) during the writing operation is not increased.

Also, by performing the coupling relight-up operation for changing the potential on the coupling line 8 by the same amount of change but in the opposite direction to that for the change of the potential on the coupling line 8 for setting the gate voltage of the drive element 2 to a level allowing a black display, the gate voltage can be readily restored such that the data signal potential after the black display corresponds to the display state before the black display.

Furthermore, by performing the coupling blanking operation and the coupling relight-up operation within one frame interval, a pseudo-double-speed drive display can be readily achieved. For example, when one frame interval lasts for 1/60 seconds (when the scanning signal line drive frequency is 60 Hz), the normal display (writing operation) and the coupling blanking operation are performed during the first half of one frame and the coupling relight-up operation and the coupling blanking operation are performed during the first half of the frame, as shown in FIG. 3, thereby a normal image can be displayed twice within one frame interval, i.e., a double-speed drive display can be readily performed as if the scanning signal lines were driven at a frequency of 120 Hz. By providing a display at such a high (pseudo) drive frequency, screen flickering can be reduced, resulting in a high-quality image display.

<4. Variant>

In the embodiment, black insertion drive is performed to display a black image twice per frame, as shown in FIG. 3, but the number of times of displaying the black image may be once per frame or thrice per frame or more. Also, the light-up period and the light-out period are not necessarily equal in length, and may be set to suitable lengths. Note that in the embodiment, the light-out state refers to the black display state, and so long as the black display state is maintained during the light-out period, current (which is low enough to maintain the black display) maybe provided to the light-emitting elements.

Also, the pixel circuits in the embodiment are voltage-programmed circuits, but they may be so-called current-programmed circuits (or current-controlled circuits). The current-programmed circuits are configured to receive a data signal, which is represented by a current value, rather than a voltage value, from a corresponding data signal line, but they can be considered to be the same as the voltage-programmed pixel circuits in the embodiment because the brightness of the light-emitting element is maintained based on a voltage retained in the retention capacitance even after the corresponding scanning signal line is selected.

While the embodiment has been described by taking as an example the active-matrix organic EL display device, the present invention is applicable to any active-matrix display devices employing electro-optic elements other than organic EL elements so long as pixel circuits are provided for writing pixel data to capacitances such as the retention capacitances 4. Note that in addition to organic EL elements and suchlike, the electro-optic elements as used herein encompass any elements whose optical characteristics change when electricity is provided thereto, including LEDs (Light Emitting Diodes), FEDs, charge-driven elements, liquid crystals, and E-Ink (Electronic Ink) as well as inorganic EL elements.

### INDUSTRIAL APPLICABILITY

The present invention is applicable to display devices in which liquid crystal elements or EL elements are arranged in a matrix, and is particularly suitable for display devices for displaying moving images.

1. An active-matrix display panel, comprising:
a plurality of pixel formation portions for forming an image to be displayed;
a plurality of video signal lines for transmitting a plurality of video signals representing the image to be displayed to the pixel formation portions;
a plurality of scanning signal lines crossing the video signal lines; and
a plurality of coupling lines provided along their respective scanning signal lines, wherein,
the pixel formation portions are arranged in a matrix, in correspondence with the intersections between the video signal lines and the scanning signal lines, and
each of the pixel formation portions includes:
an electro-optic element to be driven by a voltage or current;
a drive element having a control terminal and providing the voltage or current to be applied to the electro-optic element in accordance with a voltage applied to the control terminal;
a switching element for, when a corresponding scanning signal line is selected, providing the video signal transmitted through a corresponding video signal line to the control terminal;
a retention capacitance connected at one terminal to the control terminal and retaining the voltage applied to the control terminal upon selection of the corresponding scanning signal line; and
a coupling capacitance connected at one terminal to the control terminal and at the other terminal to a corresponding coupling line.

2. The active-matrix display panel according to claim 1, wherein the electro-optic element is an organic EL (Electro Luminescence) element.

3. An active-matrix display device, comprising:
an active-matrix display panel of claim 1;
a scanning signal line driver circuit for selectively driving the scanning signal lines;
a video signal line driver circuit for providing the video signals corresponding to an image to be displayed to the video signal lines; and
a coupling line driver circuit for changing a voltage on a corresponding coupling line at the start of a predetermined light-out period to be set within one frame interval in which to display a single image after selecting a corresponding scanning signal line for each of the coupling lines, the voltage being changed such that a voltage applied to the control terminal during the light-out period is set to a level allowing the electro-optic element to provide a black display.

4. The active-matrix display device according to claim 3, wherein,
the active-matrix display panel further includes power supply lines for providing a predetermined voltage or current to the drive elements,
the power supply lines are connected to the electro-optic elements via the drive elements,
the coupling line driver circuit changes the voltage on the coupling line, thereby setting a voltage applied to the control terminal acting as a gate terminal of the drive element during the light-out period to a level allowing the electro-optic element to provide a black display, the level being variable in a range including values close to the voltage on the power supply line.

5. The active-matrix display device according to claim 3, wherein the coupling line driver circuit brings the voltage on the coupling line back to its pre-change level immediately after the light-out period.

6. The active-matrix display device according to claim 5, wherein the coupling line driver circuit changes the voltage on the corresponding coupling line such that the voltage on the coupling line is brought back to its pre-change level immediately after a first light-out cycle within the light-out period, and the voltage applied to the control terminal during the light-out period is set again to a level allowing the electro-optic element to provide a black display at the start of a second light-out cycle being set at a predetermined time period apart.

7. A method for driving an active-matrix display device provided with an active-matrix display panel including a plurality of pixel formation portions for forming an image to be displayed, a plurality of video signal lines for transmitting a plurality of video signals representing the image to be displayed to the pixel formation portions, a plurality of scanning signal lines crossing the video signal lines, and a plurality of coupling lines provided along their respective scanning signal lines, the pixel formation portions being arranged in a matrix, in correspondence with the intersections between the video signal lines and the scanning signal lines, each of the pixel formation portions including an electro-optic element to be driven by a voltage or current, a drive element having a control terminal and providing the voltage or current to be applied to the electro-optic element in accordance with a voltage applied to the control terminal, a switching element for, when a corresponding scanning signal line is selected, providing the video signal transmitted through a corresponding video signal line to the control terminal, a retention capacitance connected at one terminal to the control terminal and retaining the voltage applied to the control terminal upon selection of the corresponding scanning signal line, and a coupling capacitance connected at one terminal to the control terminal and at the other terminal to a corresponding coupling line, the method comprising:
a scanning signal line driving step for selectively driving the scanning signal lines;
a video signal line driving step for providing the video signals corresponding to an image to be displayed to the video signal lines; and
a coupling line driving step for changing a voltage on a corresponding coupling line at the start of a predetermined light-out period to be set within one frame interval in which to display a single image after selecting a corresponding scanning signal line for each of the coupling lines, the voltage being changed such that a voltage applied to the control terminal during the light-out period is set to a level allowing the electro-optic element to provide a black display.
